(19) United States
(12) Patent Application Publication
(10) Pub. No.: US 2011/0209356 A1
(43) Pub. Date: Sep. 1, 2011

(54) DRYER AIR CIRCULATION SYSTEM AND METHOD

(76) Inventor: Bradley J. Goemans, Winona (CA)

(21) Appl. No.: 12/714,007

(22) Filed: Feb. 26, 2010

(51) Int. Cl. F26B 3/02; F26B 25/06

(52) U.S. Cl. 34/443; 34/218

(57) ABSTRACT

A novel clothes dryer, and an adaptor for a conventional clothes dryer, are disclosed. The novel clothes dryer and the adaptor enable a method for operating a clothes dryer located inside a building. The method comprises the steps of drawing air directly from outside the building into a dryer inlet, heating the air to produce heated air, circulating the heated air among moist textiles in a dryer drum to evaporate moisture from the textiles to produce moist heated air, and then venting the moist heated air from a dryer air outlet directly to outside the building.

### FIELD OF THE INVENTION

The present invention is directed to clothes dryers, and more particularly to hot-air clothes dryers.

### BACKGROUND OF THE INVENTION

A conventional hot-air clothes dryer operates by drawing air from the room in which it is located, heating the air, circulating the heated air among wet or damp clothes to absorb moisture from the clothes, and then venting the heated, moist air to the outside of the building (typically a dwelling) in which the clothes dryer is located.

Referring now to FIG. 1A, an exemplary prior art hot-air clothes dryer is indicated generally by the reference numeral 10A. The dryer 10A comprises a dryer housing 12A which includes a dryer air inlet 14A and a dryer air outlet 16A. The dryer 10A also includes a heater 18A, a pump 20A (in the illustrated embodiment a fan 22A driven by a motor 24A), and a driven rotating tumbler drum 26A which has drum air inlet apertures 28A located at the rear thereof. In the illustrated embodiment, the motor 24A also drives the tumbler drum 26A by way of a drive belt 30A. The dryer housing 12A also includes a door 32A enabling clothes to be placed inside the tumbler drum 26A through an open front end thereof. The door 32A is hollow and has door air inlet apertures 34A defined in its inner face so that the interior volume of the tumbler drum 26A can communicate with the interior of the door 32A, and a door outlet 36A which communicates through a lint trap 38A with the fan 22A. The fan 22A is positioned downstream of the dryer air inlet 14A, heater 18A, tumbler drum 26A, door 32A and lint trap 38A, and upstream of the dryer air outlet 16A, which communicates with the building exterior through a vent passage 40A formed by tubing that extends through an exterior wall 42A of the building.

In operation of the exemplary dryer 10A, the fan 22A draws air, denoted by the arrows 44, into the dryer housing 12A through the dryer air inlet 14A. The air 44 is drawn past the heater 18A, which heats the air 44, and then through the drum air inlet apertures 28A into the tumbler drum 26A. Inside the tumbler drum 26A, the heated air 44 absorbs moisture from the clothing (not shown) as the tumbler drum 26A rotates, and then the heated, moist air 44 passes through the door air inlet apertures 34A into the hollow interior of the door 32A. The heated, moist air 44 is then drawn through the door outlet 36A and the lint trap 38A, which captures fibers carried by the heated, moist air 44, and then continues past the fan 22A through the vent passage 40A to the exterior of the building.

FIG. 1B shows an exemplary prior art hot-air clothes dryer 12B which is identical to the exemplary prior art dryer 12A except that the dryer air inlet, denoted by reference numeral 14B, is located at a dryer air intake region at the rear of the dryer 12B, rather than at the front as with the exemplary prior art dryer 12A, and comprises a plurality of apertures 15B. As such, identical reference numerals, except with the suffix “B” instead of “A”, are used to denote corresponding features.

With hot-air clothes dryers such as those described above, it is important that the heated, moist air be vented to the outside of the building, otherwise the moisture can result in the development of mould or otherwise damage the building.

As more and more buildings, and particular houses, become well insulated and effectively sealed from the outside environment when the doors and windows are closed, the drawing of air from inside the room can be problematic, since the insulation and sealing impedes the inflow of replacement air into the building.

### SUMMARY OF THE INVENTION

In one aspect, the present invention is directed to a method for operating a hot-air clothes dryer located inside a building. The method comprises the steps of drawing air directly from outside the building into a dryer inlet, heating the air to produce heated air, circulating the heated air among moist textiles in a dryer drum to evaporate moisture from the textiles to produce moist heated air, and venting the moist heated air from a dryer air outlet directly to outside the building.

In one embodiment of the method, the step of drawing air directly from outside the building into the dryer inlet comprises drawing air along an intake air passage, and
the step of venting the moist heated air from the dryer air outlet directly to outside the building comprises venting the moist heated air along an output air passage. In a particular embodiment, the intake air passage and the output air passage each include concentrically arranged portions.

In another aspect, the present invention is directed to a hot-air clothes dryer. The dryer comprises a dryer air inlet connectible in fluid communication along an intake air passage with an inlet aperture disposed outside of the building so as to receive air directly from outside a building, with the dryer air inlet being in fluid communication along a heated path with a drying chamber. The dryer further comprises a dryer air outlet in fluid communication with the drying chamber and connectible in fluid communication along an output air passage with an outlet aperture disposed outside of the building, and a pump for moving air from the inlet aperture, along the intake air passage to the dryer air inlet, along the heated path and through the drying chamber to the dryer air outlet, and along the output air passage to the outlet aperture. The output air passage is isolated from the intake air passage.

In one embodiment, the dryer further comprises linkages defining the intake air passage and the output air massage, and the intake air passage and the output air passage each include concentrically arranged portions.

In a further aspect, the present invention is directed to an adaptor for a hot-air clothes dryer. The adaptor comprises an adaptor housing securable over an air intake region of the dryer to be in sealed fluid communication with an air inlet of the dryer and an adaptor housing inlet connectible in sealed fluid communication with an air intake linkage. In one embodiment, the adaptor further comprises an elongate air intake linkage that has a first end secured to the adaptor housing inlet so as to be in sealed fluid communication with the dryer air inlet and a second end defining an inlet aperture that is in fluid communication with the first end of the air intake linkage to define an intake air passage therebetween. The air intake linkage is extendible through an aperture in an exterior building wall to position the inlet aperture exteriorly of the exterior building wall to receive air from outside the building.

The adaptor may further comprise an air output linkage having a first end securable in sealed fluid communication with a dryer air outlet of the dryer and a second end defining an outlet aperture. In such an embodiment, the first end of the air output linkage is in fluid communication with the outlet aperture to define an output air passage that is isolated from the intake air passage. The adaptor housing may be simultaneously sealingly securable over both the air intake region of the dryer and over a dryer air outlet region of the dryer. In this embodiment, the adaptor housing has an adaptor housing outlet securable in sealed fluid communication with an air outlet of the dryer, and the first end of the air output linkage is securable in sealed fluid communication with the adaptor housing outlet so that the first end of the air output linkage is in sealed fluid communication with the dryer air outlet. In particular embodiments, the intake air passage and the output air passage each include concentrically arranged portions.

### BRIEF DESCRIPTION OF THE DRAWINGS

These and other features of the invention will become more apparent from the following description in which reference is made to the appended drawings wherein:

FIG. 1A is a schematic cross-sectional view of a first prior art hot-air clothes dryer and its surrounding environment;

FIG. 1B is a schematic cross-sectional view of a second prior art hot-air clothes dryer and its surrounding environment;

FIG. 2 is a schematic cross-sectional view of a first exemplary embodiment of a hot-air clothes dryer according to an aspect of the present invention, shown in its surrounding environment;

FIG. 3A is a schematic cross-sectional view of a second exemplary embodiment of a hot-air clothes dryer according to an aspect of the present invention, shown in its surrounding environment;

FIG. 3B is a schematic cross-sectional view of a third exemplary embodiment of a hot-air clothes dryer according to an aspect of the present invention, shown in its surrounding environment;

FIG. 4 is a schematic cross-sectional view of a first exemplary embodiment of an adaptor according to an aspect of the present invention secured to a conventional hot-air clothes dryer, shown in its surrounding environment;

FIG. 5A is a schematic cross-sectional view of a second exemplary embodiment of an adaptor according to an aspect of the present invention secured to a conventional hot-air clothes dryer, shown in its surrounding environment; and

FIG. 5B is a schematic cross-sectional view of a third exemplary embodiment of an adaptor according to an aspect of the present invention secured to a conventional hot-air clothes dryer, shown in its surrounding environment.

### DETAILED DESCRIPTION

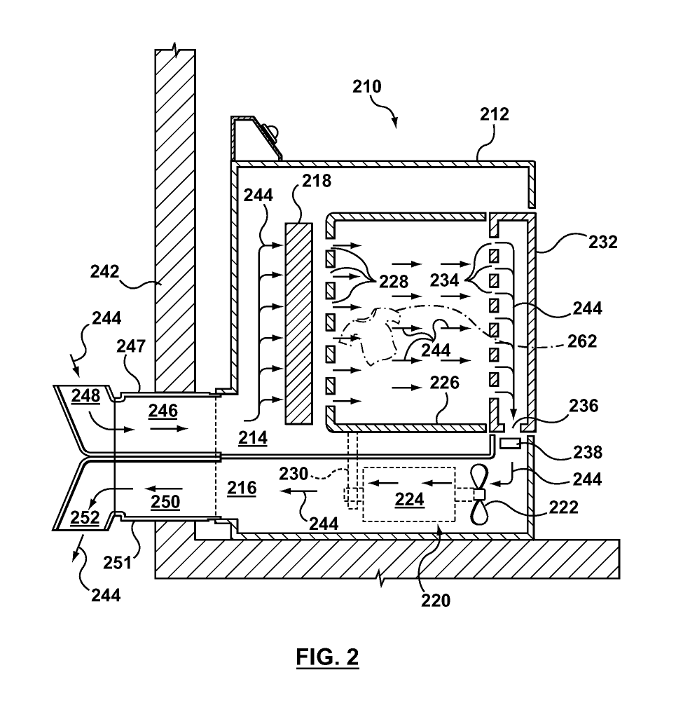

With reference now to FIG. 2, a first exemplary hot-air clothes dryer according to an aspect of the present invention is indicated generally by the reference numeral 210. The first exemplary dryer 210 is similar to the exemplary prior art clothes dryer 10B, and comprises a dryer housing 212 which includes a dryer air inlet 214 and a dryer air outlet 216. Like the prior art dryer 10B, the first exemplary dryer 210 comprises a heater 218, a pump 220 comprising a fan 222 driven by a motor 224, as well as a driven rotating tumbler drum 226 having drum air inlet apertures 228 located at the rear thereof, with the motor 224 also driving the tumbler drum 226 by way of a drive belt 230. As with the prior art dryer 10B, a hollow door 232 permits access to the tumbler drum 226, and includes door air inlet apertures 234 enabling air 244 inside the interior volume of the tumbler drum 226 to communicate through the interior of the door 232, door outlet 236 and a lint trap 238 with the fan 222. Like the prior art dryer 10B, when installed for use the first exemplary dryer 210 is located inside a building, adjacent a wall 242 thereof.

Unlike the illustrated prior art dryer 10B, which draws air from inside the room in which it is situated, when installed the exemplary dryer 210, as well as other dryers constructed, adapted or operated in accordance with aspects of the present invention, will draw intake air directly from the exterior of the building in which the dryer is located.

The dryer air inlet 214 of the first exemplary dryer 210 shown in FIG. 2 is connectible in fluid communication with an inlet aperture disposed outside of the building so as to receive air directly from outside a building. As shown in FIG. 2, when so connected the dryer air inlet 214 communicates along an intake air passage 246 defined by a linkage 247 with an inlet aperture 248 disposed outside of the building in which the first exemplary dryer 210 is situated so as to receive air directly from outside the building. The dryer air inlet 214 is in communication along a heated path with a drying chamber; in the first exemplary dryer 210 air entering through the dryer air inlet 214 is drawn past the heater 218 into the tumbler drum 226. The dryer air outlet 216 is in communication with the drying chamber and via an output air path with an outlet aperture disposed outside of the building. In the first exemplary dryer 210, air from the tumbler drum 226 is drawn into the door air inlet apertures 234, through the interior of the door 232, door outlet 236 and lint trap 238 to the dryer air outlet 216 and then along an output air passage 250 defined by a linkage 251 with an outlet aperture 252 disposed outside of the building. The pump 220 comprising the motor 224 and fan 222 moves air, denoted by arrows 244, from the inlet aperture 248, along the intake air passage 246 to the dryer air inlet 214, along the heated path, that is, past the heater 218, and through the drying chamber, in this case the tumbler drum 226, to the dryer air outlet 216, and then along the output air passage 250 to the outlet aperture 252.

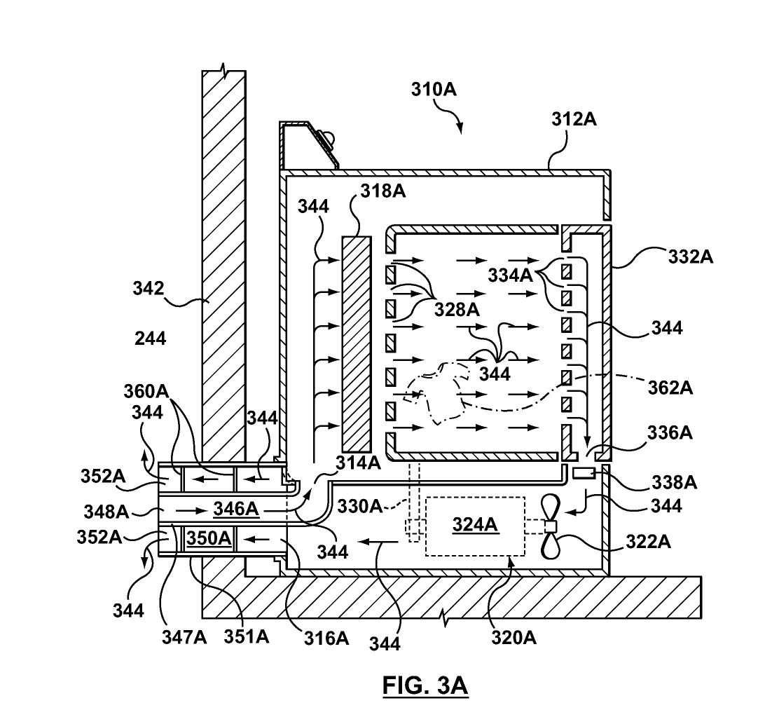

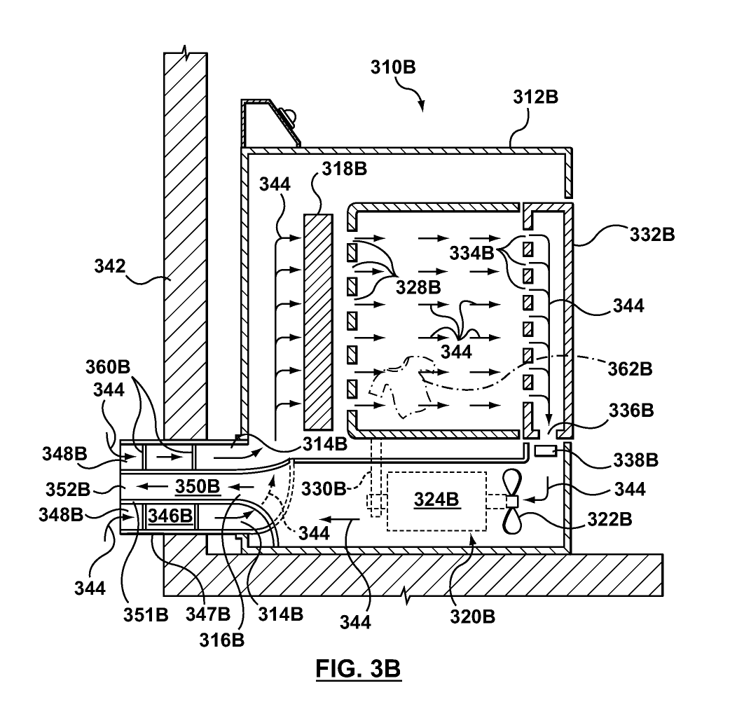

FIGS. 3A and 3B show second and third exemplary dryers, respectively, according to aspects of the present invention, denoted generally by the reference numerals 310A and 310B. The second and third exemplary dryers 310A, 310B are similar to the first exemplary dryer 210, and as such, identical reference numerals are used to denote corresponding features, except with the prefix “3” instead of “2” and the suffix “A” for the second exemplary dryer 310A and the suffix “B” for the third exemplary dryer 310B. The exterior wall is denoted by reference 342, and the flow of air is denoted by arrows 344, in both FIGS. 3A and 3B.

Whereas in the first exemplary dryer 210 shown in FIG. 2, the intake air passage 246 and the output air passage 250 comprise two separate, adjacent passages defined by adjacent linkages 247, 251, in the second exemplary dryer 310A and third exemplary dryer 310B, the intake air passages 346A, 346B and the output air passages 350A, 350B each include concentrically arranged portions. In the second exemplary dryer 310A a portion of the linkage 347A defining the intake air passage 346A is disposed within, and surrounded by, a corresponding portion of the linkage 351A defining the output air passage 350A and supported by spokes 360A. Conversely, in the third exemplary dryer 310B, a portion of the linkage 351B defining the output air passage 350B is disposed within, and surrounded by, a corresponding portion of the linkage 347B defining the intake air passage 346B and supported by spokes 360B.

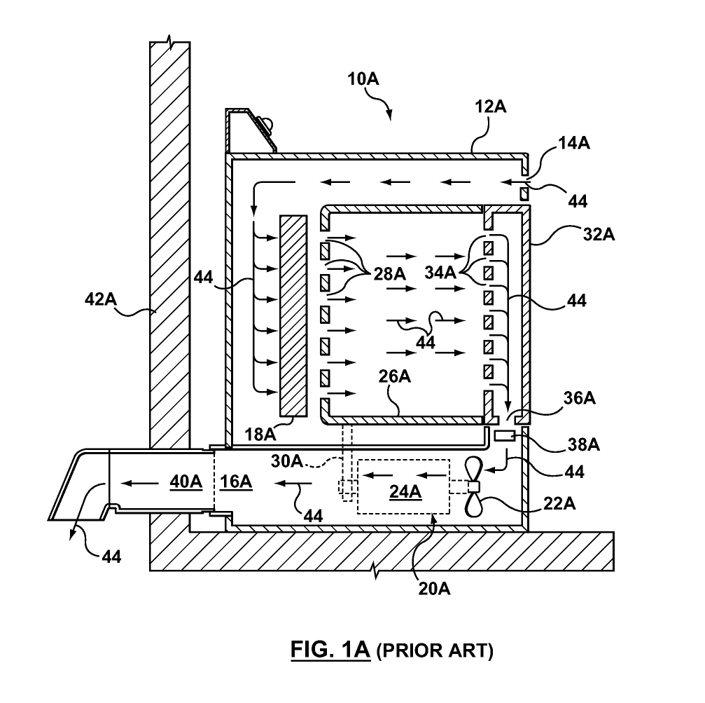

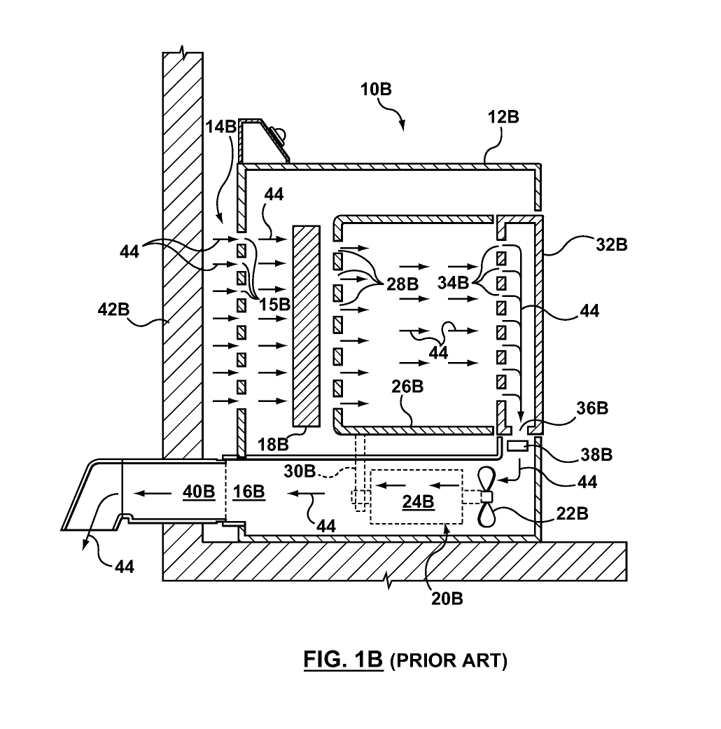

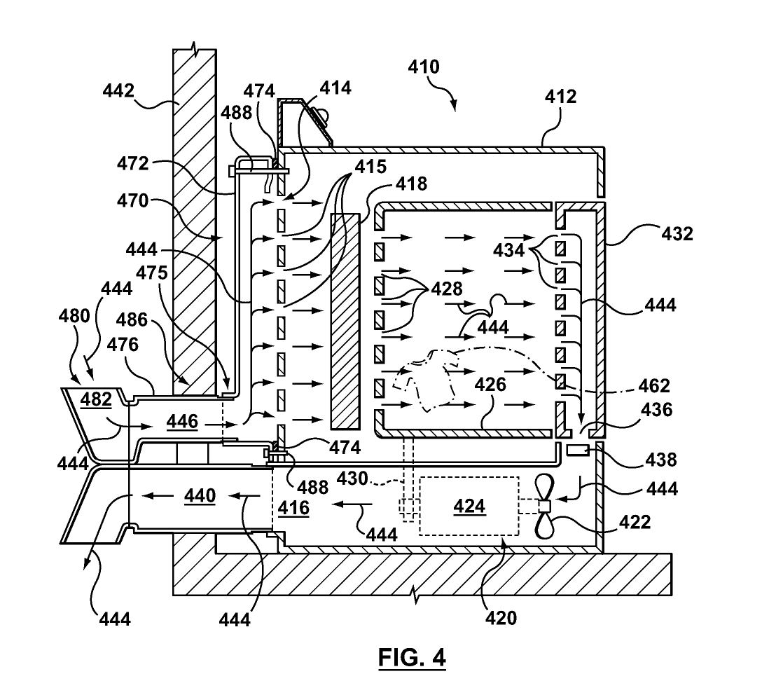

With reference now to FIG. 4, a first exemplary adaptor for adapting a prior art hot-air clothes dryer to function in accordance with aspects of the present invention is indicated generally by the reference numeral 470, and is shown secured to an exemplary prior art clothes dryer 410. The prior-at clothes dryer 410 is identical to the prior art clothes dryer depicted in, and described in respect of, FIG. 1B, and accordingly corresponding reference numerals are used to denote corresponding features, except with the prefix “4” and without the suffix “B”. The flow of air is denoted by arrows 444.

The first exemplary adaptor 470 comprises an adaptor housing 472 securable over the air intake region in which the air inlet 414 of the dryer 410 is located, that is, over the apertures 415 comprising the air inlet of the dryer 410. The adaptor housing 472 may be secured over the air intake region by any suitable means, including without limitation magnets and bolts, and is preferably removably secured over the air intake region. In the embodiment shown in FIG. 4, bolts 488 are used to secure the adaptor housing 472. The adaptor housing 472, when secured over the air intake region, is in sealed engagement with the dryer 410, and such seal may be achieved by any suitable technique. In the illustrated embodiment, sealing between the adaptor housing 472 and the dryer 410 is achieved by way of a resilient gasket 474 disposed on the mating surface of the adaptor along the outer edge thereof.

An adaptor housing inlet 475 is connectible in sealed fluid communication with an elongate air intake linkage 476. The air intake linkage 476 has a first end 478 that can be sealingly secured to the adaptor housing inlet 475 in fluid communication therewith, as shown in FIG. 4, and therefore in sealed fluid communication with the dryer air inlet 414. The air intake linkage 476 has a second end 480 defining an inlet aperture 482. The inlet aperture 482 is in fluid communication with the first end 478 of the air intake linkage 476 to define an intake air passage 446 therebetween. As such, when the adaptor 470 is secured to the dryer 410 and the air intake linkage 476 is secured to the adaptor housing inlet 475, the inlet aperture 482 defined by the second end 480 of the air intake linkage 476 is in sealed fluid communication with the dryer air inlet 414.

The air intake linkage 476 is extendible through an aperture 486 in the exterior building wall 442 to position the inlet aperture 482 exteriorly of the exterior building wall 442 to receive air from outside the building. The air intake linkage 476 may be a rigid linkage or a flexible linkage.

Accordingly, where a prior art hot-air dryer such as the dryer 410 is equipped with an adaptor according to an aspect of the present invention, such as the first exemplary adaptor 470, operation of the combined dryer 410 and adaptor 470 will be as follows. The fan 422 draws air, denoted by the arrows 444, directly from outside of the building. In particular, the fan 422 draws air 444 into the inlet aperture 482 defined by the second end 480 of the air intake linkage 476, along the air intake linkage 476, through the first end 478 of the air intake linkage 476 and the adaptor housing inlet 475, into the adaptor housing 472 and through the dryer air inlet 414 into the dryer housing 412. The dryer 410 itself operates in the conventional manner; once inside the dryer 410 the air 444 is drawn past the heater 418, through the drum air inlet apertures 428 into the tumbler drum 426, through the door air inlet apertures 434 into the hollow interior of the door 432, through the door outlet 436 and the lint trap 438, and then past the fan 422 through the vent passage 440 to the exterior of the building.

In the first exemplary adaptor 476 shown in FIG. 4, the air intake linkage 476 is separate from, and extends through a different aperture in the exterior wall 442 than, the vent passage 440 that is defined by the outlet linkage secured at the dryer air outlet 416A and extends through the exterior wall 442 of the building. As such, it will not interfere with an existing installation of a hot-air clothes dryer, although it will require an additional aperture 486 to be formed in the exterior building wall 442.

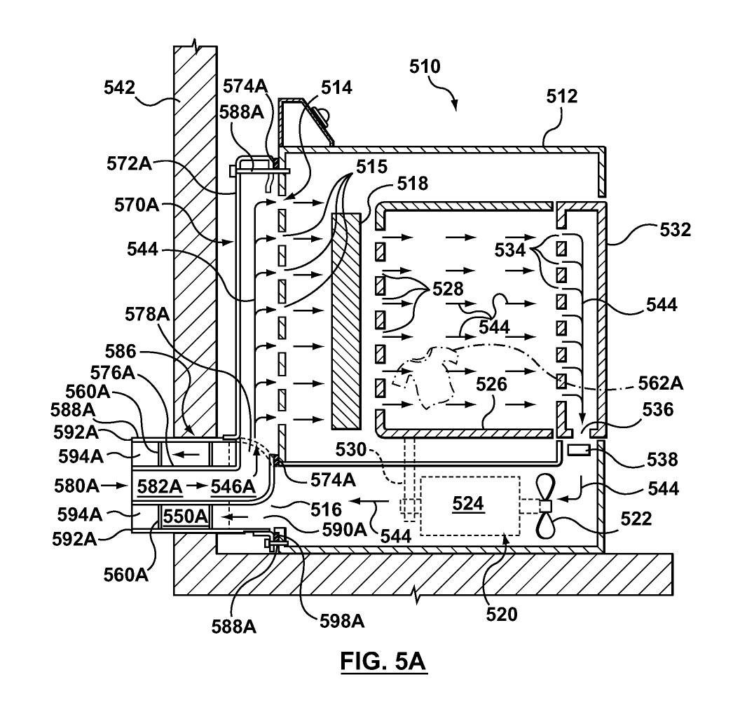

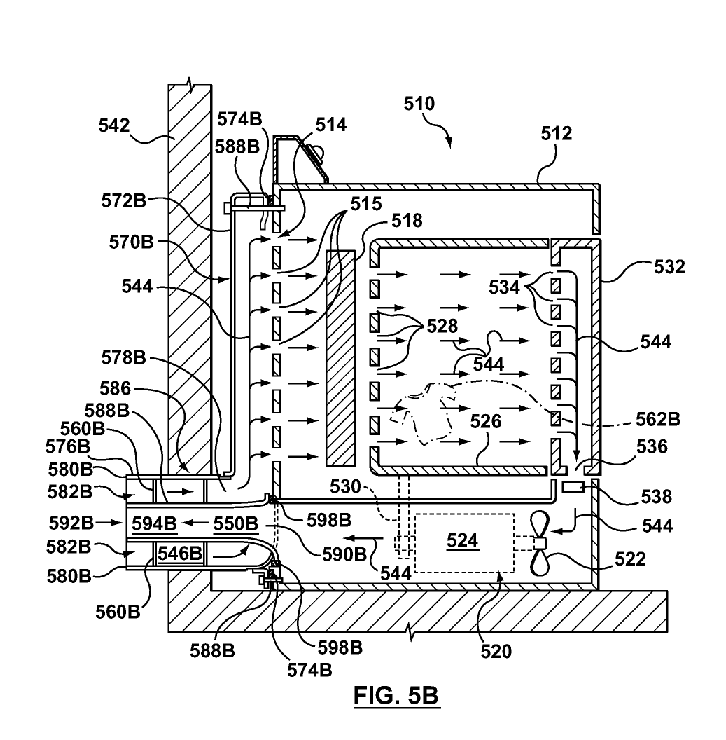

Reference is now made to FIGS. 5A and 5B, which show, respectively, a second and third exemplary adaptor according to an aspect of the present invention. The second exemplary adaptor is denoted by the reference numeral 570A, and the third exemplary adaptor is denoted by the reference numeral 570B. Both the second and third exemplary adaptors 570A, 570B are designed to adapt a prior art hot-air clothes dryer such as that shown in FIG. 1B, and hence are illustrated in association with such a prior art hot-air clothes dryer, which is denoted by the reference numeral 510 in FIGS. 5A and 5B. The prior-art clothes dryer 510 is identical to the prior art clothes dryer 410 depicted in FIG. 4, and accordingly corresponding reference numerals are used to denote corresponding features, except with the prefix “5” instead of “4”.

The second and third exemplary adaptors 570A, 570B are similar to the first exemplary adaptor 470, and as such, identical reference numerals are used to denote corresponding features, except with the prefix “5” instead of “4” and the suffix “A” for the second exemplary adaptor 570A and the suffix “B” for the third exemplary adaptor 570B. The exterior wall is denoted by reference 542, and the flow of air is denoted by arrows 544, in both FIGS. 5A and 5B.

In the first exemplary adaptor 470 shown in FIG. 4, the air intake linkage 476 is separate from, and extends through a different aperture in the exterior wall 442 than, the vent passage 440 defined by the linkage secured at the dryer air outlet 416A. As such, the original vent passage 440 from the dryer 410 remained in place. In contrast, the second exemplary adaptor 570A and the third exemplary adaptor 570B each also receive a respective air output linkage 588A, 588B having a first end 590A, 590B mounted or securable to the adaptor 570A, 570B in sealing fluid communication with the dryer air outlet 416 and a second end 592A, 592B defining an outlet aperture 594A, 594B. The first end 590A, 590B of the air output linkage 588A, 588B is in fluid communication with the outlet aperture 594A, 594B to define a sealed output air passage 550A, 550B between the outlet aperture 594A, 594B and the dryer air outlet 516. As will be described in greater detail below, in the second and third exemplary adaptors 570A, 570B the intake air passage 546A, 546B and the output air passage 550A, 550B each include concentrically arranged portions.

As can be seen in FIGS. 5A and 5B, the adaptor housing 572A, 572B is simultaneously securable over both the air intake region of the dryer 510 and also over the air outlet region of the dryer 510, that is, over the dryer air outlet 516, so as to place the first end 590A, 590B of the air output linkage 588A, 588B in sealed fluid communication with the dryer air outlet 416. Such sealing may be achieved by any suitable technique; in the illustrated embodiments a resilient gasket 598A, 598B is disposed at the edge of the first end 590A, 590B of the air output linkage 588A, 588B.

Thus, when installing either the second or third embodiments of the adaptors 570A, 570B on a dryer such as that shown in FIG. 1B (e.g. dryer 510), the linkage defining the original vent passage 40 (FIG. 1B) would be removed, and the adaptor 570A, 570B would be secured in position on the back of the dryer 410, with the adaptor housing 572A, 572B secured over the dryer air intake 514 so that the first end 578A, 578B of the air intake linkage 576A, 576B is in sealed fluid communication with the dryer air inlet 514 and the first end 590A, 590B of the air output linkage 588A, 588B is in sealed fluid communication with the dryer air outlet 516. This enables the existing aperture in the wall 542 to be used, although it may need to be widened.

As noted above, in the second and third embodiment of the adaptor 570A, 570B, the intake air passages 546A, 546B and the output air passages 550A, 550B each include concentrically arranged portions. In the second exemplary adaptor 570A a portion of the air intake linkage 576A is disposed within, and surrounded by, the air output linkage 588A and supported by spokes 560A. Conversely, in the third exemplary adaptor 570B, a portion of the air output linkage 588B is disposed within, and surrounded by, the air intake linkage 576B and supported by spokes 560B.

It is also within the contemplation of the inventors to provide an adaptor for dryers such as those shown in FIG. 1A; such adaptors would be similar to the adaptors described above with an adaptor housing shaped to sealingly engage the air intake 14A at the front of the dryer 10A. In such an embodiment, flexible tubing or other suitable connections may be used.

Thus, as illustrated in FIGS. 2 to 5B, according to an aspect of the present invention a method is provided for operating a clothes dryer located inside a building. The method comprises the steps of drawing air directly from outside the building into a dryer inlet, heating the air to produce heated air, circulating the heated air among moist textiles in a dryer drum to evaporate moisture from the textiles to produce moist heated air, and then venting the moist heated air from a dryer air outlet directly to outside the building. In FIGS. 2 to 5B, the moist textiles are denoted schematically with the reference numerals 262 to 562B, respectively. Typically, as shown in FIGS. 2 to 5B, the step of drawing air directly from outside the building into the dryer inlet comprises drawing air along an intake air passage such as intake air passage 246, 346A, 346B, 446, 546A, 546B and the step of venting the moist heated air from the dryer air outlet to outside the building comprises venting the moist heated air along an output air passage, such as output air passage 250, 350A, 350B, 450 550A, 550B. As illustrated, in certain embodiments of the method the intake air passage and the output air passage each include concentrically arranged portions.

In the first dryer embodiment 210, and the first adaptor embodiment 470, the intake air passages 246, 446 were defined by linkages 247, 476 that were separate from the linkages defining the output air passages 240, 440 and hence the intake air passages 246, 446 were isolated from the output air passages 240, 440.

In the exemplary second and third dryer embodiments 310A and 310B, and in the exemplary second and third adaptor embodiments 570A and 570B, the respective output air passage 350A, 350B, 550A, 550B, although including portions concentric with the respective intake air passage 346A, 346B, 546A, 546B, is still is isolated therefrom in the sense that the two passages do not communicate directly with one another. Air in the respective intake air passage 346A, 346B, 546A, 546B cannot reach the respective output air passage 350A, 350B, 550A, 550B except by passing through the respective dryer 310A, 310B, 410, and air in the respective output air passage 350A, 350B, 550A, 550B cannot reach the intake air passage 346A, 346B, 546A, 546B except by exiting the outlet aperture 594A, 594B and re-entering the inlet aperture 582A, 582B, which may occur to a limited extent. Notwithstanding the possibility that some air that has been expelled from the outlet aperture 594A, 594B may be drawn into the inlet aperture 582A, 582B, this is because both the outlet aperture 594A, 594B and the inlet aperture 582A, 582B communicate with the ambient environment; they do not communicate directly with one another.

Several currently preferred embodiments have been described by way of example. It will be apparent to persons skilled in the art that a number of variations and modifications can be made without departing from the scope of the invention as defined in the claims.

What is claimed is:

1. A method for operating a hot-air clothes dryer located inside a building, comprising the steps of:
(a) drawing air directly from outside the building into a dryer inlet;
(b) heating the air to produce heated air;
(c) circulating the heated air among moist textiles in a dryer drum to evaporate moisture from the textiles to produce moist heated air; and
(d) venting the moist heated air from a dryer air outlet directly to outside the building.

2. The method of claim 1, wherein:
the step of drawing air directly from outside the building into the dryer inlet comprises drawing air along an intake air passage; and
the step of venting the moist heated air from the dryer air outlet directly to outside the building comprises venting the moist heated air along an output air passage.

3. The method of claim 1, wherein the intake air passage and the output air passage each include concentrically arranged portions.

4. A hot-air clothes dryer, comprising:
a dryer air inlet connectible in fluid communication along an intake air passage with an inlet aperture disposed outside of the building so as to receive air directly from outside a building;
the dryer air inlet being in fluid communication along a heated path with a drying chamber;
a dryer air outlet in fluid communication with the drying chamber and connectible in fluid communication along an output air passage with an outlet aperture disposed outside of the building; and
a pump for moving air from the inlet aperture, along the intake air passage to the dryer air inlet, along the heated path and through the drying chamber to the dryer air outlet, and along the output air passage to the outlet aperture;
wherein the output air passage is isolated from the intake air passage.

5. The dryer of claim 4, further comprising linkages defining the intake air passage and the output air massage, and wherein the intake air passage and the output air passage each include concentrically arranged portions.

6. An adaptor for a hot-air clothes dryer, comprising:
an adaptor housing securable over an air intake region of the dryer to be in sealed fluid communication with an air inlet of the dryer; and
an adaptor housing inlet connectible in sealed fluid communication with an air intake linkage.

7. The adaptor of claim 6, further comprising:
an elongate air intake linkage, wherein:
the air intake linkage has a first end secured to the adaptor housing inlet so as to be in sealed fluid communication with the dryer air inlet and a second end defining an inlet aperture, the inlet aperture being in fluid communication with the first end of the air intake linkage to define an intake air passage therebetween; and
the air intake linkage is extendible through an aperture in an exterior building wall to position the inlet aperture exteriorly of the exterior building wall to receive air from outside the building.

8. The adaptor of claim 7, further comprising an air output linkage having a first end securable in sealed fluid communication with a dryer air outlet of the dryer and a second end defining an outlet aperture, wherein the first end of the air output linkage is in fluid communication with the outlet aperture to define an output air passage that is isolated from the intake air passage.

9. The adaptor of claim 8, wherein:
the adaptor housing is simultaneously sealingly securable over both the air intake region of the dryer and over a dryer air outlet region of the dryer;
the adaptor housing has an adaptor housing outlet securable in sealed fluid communication with an air outlet of the dryer; and
the first end of the air output linkage is securable in sealed fluid communication with the adaptor housing outlet;
so that the first end of the air output linkage is in sealed fluid communication with the dryer air outlet.

10. The adaptor of claim 7, wherein the intake air passage and the output air passage each include concentrically arranged portions.
